(19) United States
(12) Patent Application Publication
(10) Pub. No.: US 2025/0079640 A1
(43) Pub. Date: Mar. 6, 2025

(54) BATTERY CELL ASSEMBLY HAVING THERMAL BLOCKER

(71) Applicant: Ford Global Technologies, LLC, Dearborn, MI (US)

(72) Inventors: Parikshit S. Gupte, West Bloomfield, MI (US); Dominic Mario Bertolini, Birmingham, MI (US); Bhaskara Rao Boddakayala, Troy, MI (US); Giriraj Srinivasan, Troy, MI (US); John Hammack McCormick, Clawson, MI (US); Scott M. Rollins, Highland, MI (US)

(21) Appl. No.: 18/461,645

(22) Filed: Sep. 6, 2023

(51) Int. Cl. H01M 50/489; B60L 50/64; H01M 50/209; H01M 50/249; H01M 50/296

(52) U.S. Cl. CPC H01M 50/489; B60L 50/64; H01M 50/209; H01M 50/249; H01M 50/296

(57) ABSTRACT

A traction battery pack assembly includes a battery cell and a thermal blocker that is secured to the battery cell. The thermal blocker has a slot that receives at least one terminal of the battery cell. The battery cell can be a pouch-style cell. The thermal blocker can be foam.

### TECHNICAL FIELD

This disclosure relates generally to managing thermal energy within a traction battery pack and, more particularly, to incorporating a thermal blocker into a battery cell assembly.

### BACKGROUND

A traction battery pack of an electrified vehicle can include groups of battery cells arranged in one or more cell stacks. From time to time, pressure and thermal energy within one or more of the battery cells can increase and cause gas and debris to vent from those battery cells.

### SUMMARY

In some aspects, the techniques described herein relate to a traction battery pack assembly, including: a battery cell; and a thermal blocker secured to the battery cell, the thermal blocker having at least one slot that receives a terminal of the battery cell.

In some aspects, the techniques described herein relate to a traction battery pack assembly, further including an enclosure assembly that provides an interior area and a cell stack within the interior area, the battery cell within the cell stack and disposed along a cell stack axis of the cell stack.

In some aspects, the techniques described herein relate to a traction battery pack assembly, wherein the battery cell is a first battery cell and the at least one slot includes a first slot that receives a terminal of the first battery cell, the at least one slot of the thermal blocker further including a second slot that receives a terminal of a second battery cell, the second battery cell adjacent to the first battery cell along the cell stack axis.

In some aspects, the techniques described herein relate to a traction battery pack assembly, wherein the thermal blocker is a first thermal blocker secured to a first side of the battery cell and further including a second thermal blocker secured to an opposite second side of the battery cell.

In some aspects, the techniques described herein relate to a traction battery pack assembly, wherein the first and second sides are first and second outboard sides of the battery cell.

In some aspects, the techniques described herein relate to a traction battery pack assembly, wherein the battery cell is a pouch-style battery cell.

In some aspects, the techniques described herein relate to a traction battery pack assembly, wherein the at least one terminal is at least one tab terminal.

In some aspects, the techniques described herein relate to a traction battery pack assembly, further including an adhesive that secures the thermal blocker to the battery cell.

In some aspects, the techniques described herein relate to a traction battery pack assembly, wherein the adhesive is an adhesive tape.

In some aspects, the techniques described herein relate to a traction battery pack assembly, wherein the thermal blocker is adhesively secured to an outer case of the battery cell.

In some aspects, the techniques described herein relate to a traction battery pack assembly, wherein the thermal blocker is foam.

In some aspects, the techniques described herein relate to a method of managing battery pack thermal energy, including: securing a thermal blocker to a battery cell to provide a battery cell assembly; and after the securing, positioning the battery cell assembly alongside other battery cell assemblies to provide a cell stack.

In some aspects, the techniques described herein relate to a method 12, further including adhesively securing the thermal blocker to the battery cell.

In some aspects, the techniques described herein relate to a method 12, further including receiving a terminal of the battery cell within an aperture of the thermal blocker.

In some aspects, the techniques described herein relate to a method 14, wherein the terminal is a tab terminal and the battery cell is a pouch cell.

In some aspects, the techniques described herein relate to a method 12, wherein the thermal blocker is foam.

In some aspects, the techniques described herein relate to a method 12, further including situating the cell stack within an enclosure assembly.

In some aspects, the techniques described herein relate to a method, wherein the thermal blocker is a first thermal blocker secured to a first side of the battery cell and further including securing a second thermal blocker to a second side of battery cell.

In some aspects, the techniques described herein relate to a method, wherein the first and second thermal blockers each include an aperture that receives a terminal of the battery cell.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an example electrified vehicle.

FIG. 2 illustrates an expanded, perspective view of a battery pack from the electrified vehicle of FIG. 1.

FIG. 3 illustrates an expanded portion of a cell stack from FIG. 2.

FIGS. 4-6 illustrate views of an example battery cell assembly from the cell stack of FIG. 3.

### DETAILED DESCRIPTION

This disclosure details exemplary battery cell assemblies for a traction battery pack. The battery cell assemblies include at least one thermal blocker attached to a battery cell. The thermal blocker that can help to guide vent byproducts during a thermal event. As the thermal blocker is integrated with the battery cell, installing the thermal blocker separate from the battery cell may not be required.

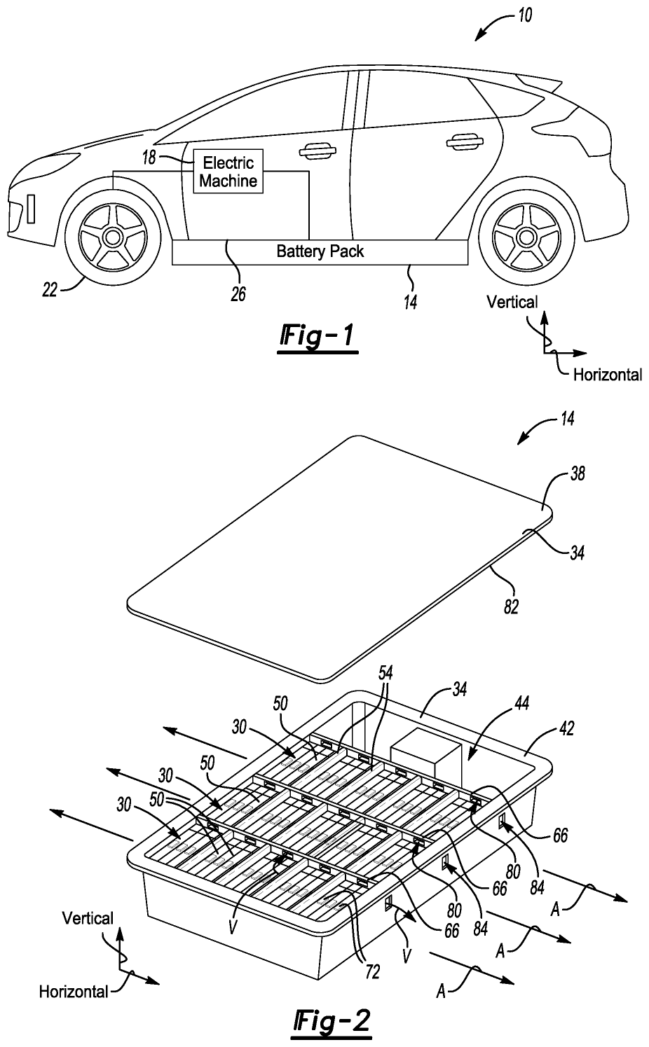

With reference to FIG. 1, an electrified vehicle 10 includes a battery pack 14, an electric machine 18, and wheels 22. The battery pack 14 powers an electric machine 18, which can convert electrical power to mechanical power to drive the wheels 22.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

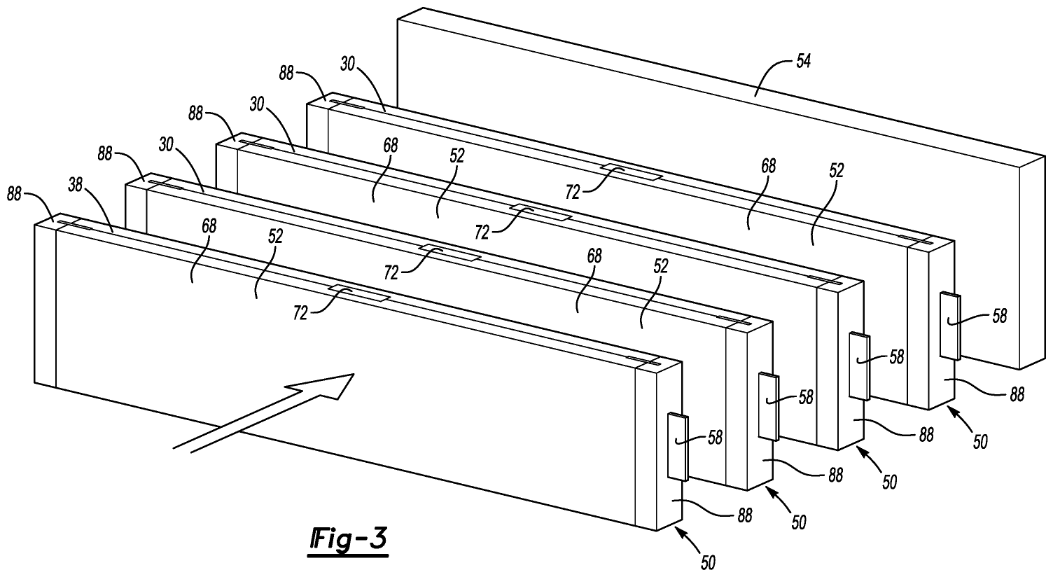

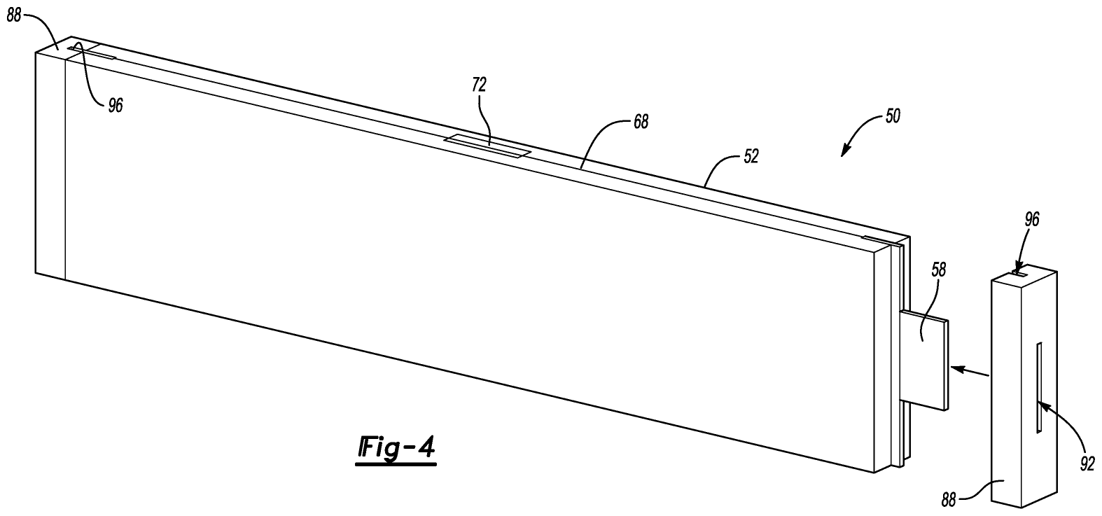

Referring to FIGS. 2 and 3, the battery pack 14 includes a plurality of cell stacks 30 held within an interior of an enclosure assembly 34. In the exemplary embodiment, the enclosure assembly 34 includes an enclosure cover 38 and an enclosure tray 42. The enclosure cover 38 is secured to the enclosure tray 42 to provide an interior area 44 that houses the cell stacks 30. The enclosure cover 38 can be secured to the enclosure tray 42 using mechanical fasteners (not shown), for example.

Each of the cell stacks 30 includes a plurality of battery cell assemblies 50 (or simply, “cell assemblies”) and a plurality of dividers 54. Within each of the cell stacks 30, the cell assemblies 50 are arranged in groups and disposed along a cell stack axis A. The dividers 54 are disposed along the cell stack axis A between groups of the cell assemblies 50. The groups of battery cell assemblies 50 can include multiple battery cell assemblies 50 or only one battery cell assembly 50.

The dividers 54 can be a mica-based material. In other examples, the dividers 54 could be an aerogel sheets, or a sheet having some other thermally insulative material or combination of thermally insulative materials.

Although specific numbers of the cell stacks 30 and cell assemblies 50 are illustrated in the various figures of this disclosure, the battery pack 14 could include any number of the cell stacks 30 having any number of individual cell assemblies 50.

The battery cell assemblies 50 include battery cells 52 that store and supply electrical power. In an embodiment, the battery cells 52 are lithium-ion pouch-style battery cells. Each of the battery cells 52 includes terminal tabs 58 extending laterally outward from an outer case 68.

Although described as pouch-cells, battery cells having other geometries (cylindrical, prismatic, etc.) other chemistries (nickel-metal hydride, lead-acid, etc.), or both could alternatively be utilized within the scope of this disclosure.

From time to time, pressure and thermal energy within one or more of the battery cells 52 can increase. The pressure and thermal energy increase can be due to an overcharge condition, for example. The pressure and thermal energy increase can cause a vent 72 within the outer case 68 of associated battery cell 52 to rupture. Vent byproducts V, such as gas and debris, are then expelled from within the battery cell 52. The vent byproducts V can be released from the associated battery cell 52 through the vent 72 within the outer case 68, such as a membrane that yields in response to increased pressure, or through a ruptured area of the outer case 68.

The vent byproducts V can have relatively high thermal energy levels. Guiding the vent byproducts V away from other battery cell 52 that are not venting can prevent those battery cells 52 from venting and the venting event cascading through the battery pack 14.

The battery pack 14, in these examples, includes cross-member assemblies 76 disposed between cell stacks 30. The cross-member assemblies 76 include venting passageways and openings 80 to the venting passageways. Vent byproducts V vented through the vent 72 of one or more of the battery cell assemblies 50 can move through at least one of the openings 80 into one of the venting passageways. The vent byproducts V are communicated from the venting passageway through an enclosure vent 84 to an area outside the battery pack 14.

The openings 80, the enclosure vent 84, or both can be covered by respective membranes, for example, when venting is not needed. During venting, the vent byproducts can rupture the membranes so that the vent byproducts can flow from the battery cells 52, through the openings 80 to the venting passageway and then through the enclosure vent 84. The example cross-member assemblies 76 extend longitudinally in a direction that is parallel to the cell stack axes A. The cross-member assemblies 76 and the cell stack axes A extend in a cross-vehicle direction (i.e., from a driver side to a passenger side).

The dividers 54 can vertically and horizontally extend from the cell stack axis A to contact the enclosure assembly 34 and cross-member assemblies 76 to effectively compartmentalize groups of the battery cell assemblies 50.

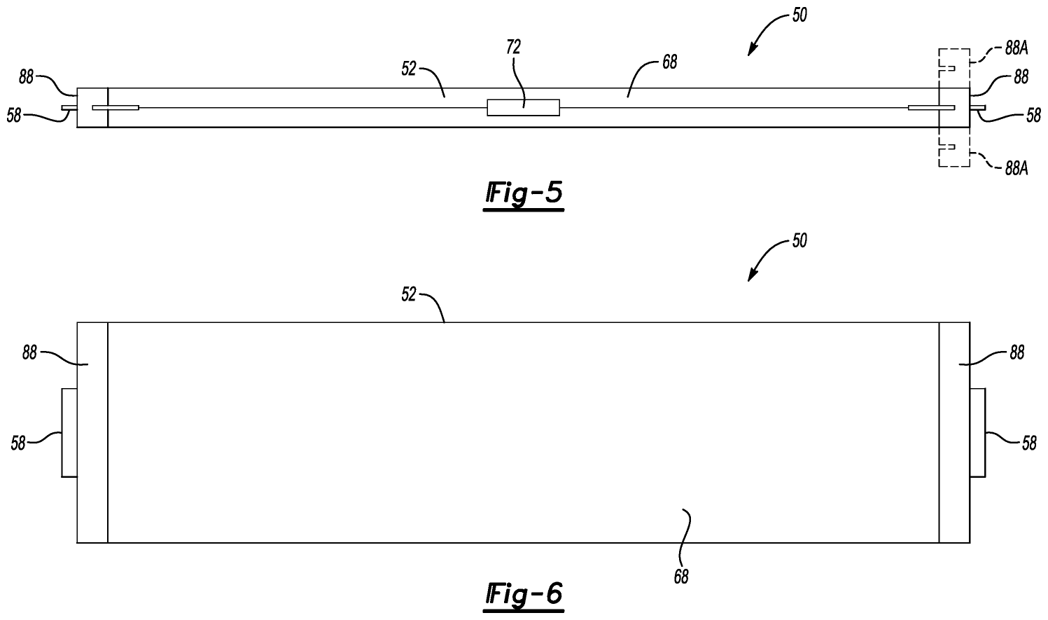

With reference now to FIGS. 3-6 and continued reference to FIG. 2, the battery cell assemblies 50 include thermal blockers 88 attached to the battery cells 52. The thermal blockers 88 can facilitate venting. In particular, the thermal blockers 88 can help to fill and insulate otherwise open spaces within interior area 44, which can guide and direct vent byproducts V outward through the openings 80 into the venting passageways within the cross-member assemblies 76.

The thermal blockers 88 can, together with the dividers 54, confine the vent byproducts V and can help to block movement of vent byproducts from one group of the battery cell assemblies 50 to another group of the battery cell assemblies 50. Thus, thermal energy associated with the vent byproducts is prevented from heating battery cell 52 in other groups and causing those battery cells 52 to vent.

The battery cell assemblies 50 each include two thermal blockers 88 in this example. Other example battery cell assemblies 50 could include a single thermal blocker 88 (if thermal blocking is only desired on one side of the cell stack, for example) or more than two thermal blockers.

The thermal blockers 88 are disposed along the outboard sides of the battery cells 52. The thermal blockers 88, in this example, each include apertures 92 receive one of the terminal tabs 58. The terminal tabs 58 can extend through the apertures 92 from the outer case 68 to a busbar (not shown).

The thermal blockers 88, in this example, each include a notch 96 that receives a portion of the outer case 68, which can help to position the thermal blockers 88 relative to the outer case 68 and the terminal tabs 58.

An adhesive can be used to secure the thermal blockers 88 to battery cells 52. The adhesive could be an adhesive tape, for example. The thermal blockers 88 are secured to the battery cells 52 prior to assembling the battery cells 52 into the cell stacks 30.

The thermal blockers 88 are foam in this example. In particular, the thermal blockers 88 are a closed-cell foam.

With the exemplary battery cell assemblies 50, after assembling the battery cell assemblies 50 and dividers 54 to provide the cell stacks 30, the cell stacks 30 include thermal blockers 88 along opposing outboard sides of the cell stacks 30. The apertures 92 permit the terminal tabs 58 to extend to a busbar, if required.

In this example, the battery cells 52 include a thermal blocker 88 that receives one of the terminal tabs 58. In another example, the thermal blocker 88 could be made axially wider and include a slot for receiving a terminal tab of an axially adjacent battery cell-a cell that lacks an attached thermal blocker. An example of how the thermal blocker 88 could be axially expanded is shown in broken lines by areas 88A in FIG. 5. The thermal blocker 88 would be molded to include the areas 88A.

Features of the disclosed examples include battery cell assemblies having integrated thermal blockers. The thermal blockers can help to, among other things, reduce conductive thermal energy transfer between cells. Integrating the thermal blockers into the battery cell assemblies can facilitate assembly as individually placing thermal blockers within the battery pack may not be required.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
a battery cell; and
a thermal blocker secured to the battery cell, the thermal blocker having at least one slot that receives a terminal of the battery cell.

2. The traction battery pack assembly of claim 1, further comprising an enclosure assembly that provides an interior area and a cell stack within the interior area, the battery cell within the cell stack and disposed along a cell stack axis of the cell stack.

3. The traction battery pack assembly of claim 2, wherein the battery cell is a first battery cell and the at least one slot includes a first slot that receives a terminal of the first battery cell, the at least one slot of the thermal blocker further including a second slot that receives a terminal of a second battery cell, the second battery cell adjacent to the first battery cell along the cell stack axis.

4. The traction battery pack assembly of claim 1, wherein the thermal blocker is a first thermal blocker secured to a first side of the battery cell and further comprising a second thermal blocker secured to an opposite second side of the battery cell.

5. The traction battery pack assembly of claim 4, wherein the first and second sides are first and second outboard sides of the battery cell.

6. The traction battery pack assembly of claim 1, wherein the battery cell is a pouch-style battery cell.

7. The traction battery pack assembly of claim 1, wherein the terminal is a tab terminal.

8. The traction battery pack assembly of claim 1, further comprising an adhesive that secures the thermal blocker to the battery cell.

9. The traction battery pack assembly of claim 8, wherein the adhesive is an adhesive tape.

10. The traction battery pack assembly of claim 1, wherein the thermal blocker is adhesively secured to an outer case of the battery cell.

11. The traction battery pack assembly of claim 1, wherein the thermal blocker is foam.

12. A method of managing battery pack thermal energy, comprising:
securing a thermal blocker to a battery cell to provide a battery cell assembly; and
after the securing, positioning the battery cell assembly alongside other battery cell assemblies to provide a cell stack.

13. The method of managing battery pack thermal energy of claim 12, further comprising adhesively securing the thermal blocker to the battery cell.

14. The method of managing battery pack thermal energy of claim 12, further comprising receiving a terminal of the battery cell within an aperture of the thermal blocker.

15. The method of managing battery pack thermal energy of claim 14, wherein the terminal is a tab terminal and the battery cell is a pouch cell.

16. The method of managing battery pack thermal energy of claim 12, wherein the thermal blocker is foam.

17. The method of managing battery pack thermal energy of claim 12, further comprising situating the cell stack within an enclosure assembly.

18. The method of claim 12, wherein the thermal blocker is a first thermal blocker secured to a first side of the battery cell and further comprising securing a second thermal blocker to a second side of battery cell.

19. The method of claim 18, wherein the first and second thermal blockers each include an aperture that receives a terminal of the battery cell.
